(19) United States
(12) Patent Application Publication
(10) Pub. No.: US 2011/0099049 A1
(43) Pub. Date: Apr. 28, 2011

(54) SYSTEM AND METHOD FOR THE GENERATION AND DISTRIBUTION OF AN ELECTRONIC INTERACTIVE CALL SHEET

(75) Inventors: Richard Alan Kwiat, Boulder, CO (US); James Michael Robertson, Jupiter, FL (US)

(73) Assignee: MOBILE IMAGINATION, LLC, Boulder, CO (US)

(21) Appl. No.: 12/913,547

(22) Filed: Oct. 27, 2010

Related U.S. Application Data
(60) Provisional application No. 61/255,274, filed on Oct. 27, 2009.

(51) Int. Cl. G06Q 10/00

(52) U.S. Cl. 705/7.34

(57) ABSTRACT

A system and method for the generation and distribution of an electronic call sheet. The method includes receiving geographic information for a shoot location, and a date for when a production shoot will be held at the shoot location. A user selected location parameter is determined that is associated with the geographic information. One or more listings are accessed from a directory for at least one category of information. The accessing of listings is based on the geographic information, the user selected location parameter, and the date. The directory includes a listing of entities providing products or services relevant to the production industry. The listing are presented to a user for selection, whereupon a selection of the one or more listings is received. Information related to the selection is included into an entry that is incorporated into a call sheet associated with the production shoot.

### CROSS REFERENCE TO RELATED APPLICATIONS

The present application claims priority to and the benefit of U.S. Provisional Patent Application No. 61/255,274, entitled “Electronic Interactive Call Sheet and Push Job Notification,” filed on Oct. 27, 2009, which is herein incorporated by reference in its entirety. The present application is related to U.S. patent application Ser. No. ______, entitled “System And Method For Pushing Notifications of Postings,” filed on Oct. 27, 2010, and with the same inventors, which is herein incorporated by reference in its entirety.

### BACKGROUND OF THE INVENTION

1. Field of the Invention

The present invention relates to distributing information used in the production industry and more specifically to the generation and distribution of a call sheet through a communication network.

2. The Relevant Technology

The production industry operates to create multimedia content for news, advertising, performing arts, film, radio, and television. During a production cycle, the production shoot is the period where the content is created. As an example, when producing a film, a production shoot involves the filming of a particular scene that is later incorporated with other scenes to make the film.

Planning for a production shoot may be quite complex, depending on the number of persons involved and what type of content is being created. Even a shoot that is onsite for 6-8 hours will involve multiple entities providing talent, products, and services. For instance, the cast and crew and the various services necessary to support the shoot need to be prearranged in order to facilitate a successful shoot. Some considerations for services may include, in part, set construction, arranging for hotel accommodations, food, transportation, and medical services.

While planning for and managing the production cycle, it becomes extremely difficult to remain engaged in the direct process of managing the production shoot, while simultaneously managing all related resources, such as employees, freelancers, contractors, consultants, suppliers, and other vendors supporting the production shoot. That is, while the tendency may exist to focus on the creative side of creating content, the practical and logistical side of a production shoot is also important and may become too cumbersome, especially as the production shoot becomes more complex (e.g., multiple days of shoot using larger numbers of cast and crew).

In addition, distributing information to relevant individuals involved in a production shoot becomes problematic as the numbers of individuals increase, and as modifications to the scheduling or the management of the production shoot changes. It is common for individuals to be unaware of the details of a production shoot because they were not given the information. Also, individuals may not be unaware of updates to the management of the production shoot, because although they were given the original information, they were not given or not made aware of the updated information.

It is desirous to explore ways to facilitate the management of a production cycle, especially during a production shoot.

### SUMMARY OF THE INVENTION

The present invention relates to the field of managing the development and production of multimedia, to include, in part, news segments, performing arts, advertising, film, radio, or a television program. Specifically, embodiments of the present invention relate to the generation and distribution of an electronic call sheet through the use of a central platform supporting the production industry.

In one embodiment, a method for generating and distributing an electronic call sheet is disclosed. For instance, a user interfaces with the central platform in order to access information needed to complete an electronic call sheet. The user may interface with the central platform using a mobile device, or through any computing resource that is able to communicatively couple the resource to the central platform. The method includes receiving geographic information for a shoot location, and a date for when a production shoot will be held at the shoot location. That is, information relevant to the production shoot is collected and used to facilitate the generation of the call sheet. A user selected location parameter is optionally determined that is associated with the geographic information. This parameter is used to filter information used for generating the call sheet. As such, one or more listings are accessed from a directory for at least one category of information, based on the geographic information, the user selected location parameter, and the date. This ensures that only relevant information is included in the electronic call sheet. The directory includes listings of entities providing products or services relevant to the production industry, and in one embodiment is managed by the central platform. In particular, the directory is maintained so that any need arising during a production shoot can be addressed by a listing in the directory. The listings are presented to a user for selection, whereupon a selection of the one or more listings is received from the user. Information related to the selection that is suitable for quick reference within a call sheet is generated as an entry. The entry is further incorporated into a call sheet associated with the production shoot.

In another embodiment, a platform for distributing information is disclosed. The platform is accessed through a communication network. For instance, the platform may be accessed through a mobile computing device through a telecommunication network, or through any computing resource able to communicate with the platform through any communication network (e.g., internet). The platform includes a directory that includes a plurality of listings of entities providing products or services related to the production industry. That is, the directory is maintained by the platform as a resource for products and services that are needed to support the production industry, especially during a production shoot. The platform includes a listings presenter for presenting one or more listings for at least one category of information based on geographic information associated with a shoot location, a date of a production shoot held at the shoot location, and a user selected location parameter provided by a user. The listings are accessed from the directory. The listings are presented to the user for selection. In addition, the platform includes a selection handler for receiving a selection of the one or more listings by a device associated with the user. Information related to the selection that is suitable for referencing is included in an entry by a call sheet editor that is then incorporated into an electronic call sheet that is associated with the production shoot.

In still another embodiment, an electronic call sheet is disclosed. The electronic call sheet includes geographic information for a shoot location. In addition, a user selected location parameter is associated with the electronic call sheet, wherein the parameter is used to filter information relevant for inclusion in the call sheet. A date for when a production shoot will be held at the shoot location is also associated with the electronic call sheet. The electronic call sheet includes at least one entry that comprises information related to an entity that provides products or services in support of the production shoot. For instance, the entry may relate to a listing associated with a category of information. More specifically, the entry contains information related to a selection of one or more listings provided for selection for the category of information as accessed from a directory. The directory includes listings of entities providing products and/or services relevant to the production industry. The one or more listings provided for selection is determined based on the geographic information, the user selected location parameter, and the date.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system including a central platform that is capable of supporting the generation and distribution of electronic or digital call sheets, in accordance with one embodiment of the present invention.

FIG. 2 is a block diagram of a back-end server 200 that includes the central platform 130, in accordance with one embodiment of the present invention.

FIG. 3 is a diagram illustrating a flow chart 300 disclosing a method for generating and distributing information, such as an electronic call sheet, in accordance with one embodiment of the present invention.

FIG. 4 is a data flow diagram 400 illustrating the flow of information when generating a call sheet, in accordance with one embodiment of the present invention.

FIG. 5 is a data flow diagram 500 illustrating the flow of information when distributing a new or updated call sheet, in accordance with one embodiment of the present invention.

FIGS. 6A-C are illustrations of an exemplary call sheet generated and distributed by the systems and methods described in FIGS. 1-5, in accordance with one embodiment of the present invention.

### DETAILED DESCRIPTION OF THE PREFERRED EMBODIMENTS

Reference will now be made in detail to the preferred embodiments of the present invention, to include a system and method for the generation and distribution of electronic call sheets. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for a central platform that facilitates the generation and distribution of a call sheet to cast and crew members of a production shoot, and to any other person supporting the production shoot. Still other embodiments provide the above advantage, and further provide management tools for industries that operate in the field, such that instant access and communication with various resources and needs to organize various entities, resources, and locations around a specific project, job, or production shoot is provided. Other embodiments of the present invention provide the above advantages, and further provide for the generation of a call sheet using a directory providing industry specific listings of entities that support the production industry. For instance, resources necessary to support a production shoot can be found in the directory. Still other embodiments of the present invention provide the above advantages, and further provide for the generation of the call sheet using a computing resource that is communicatively coupled to the central platform, wherein the computing resource is a mobile device, a stand-alone computer, or a combination of the two. Still other embodiments provide the above advantages, and further provide for the distribution of the call sheet to all participating recipients supporting the production shoot. Specifically, the most recent call sheet is always available or automatically pushed to a corresponding device associated with a recipient. Further, other embodiments provide the above advantages, and further provide for a notification system, that alerts a participating recipient that a new or updated call sheet is available. Still other embodiments provide the above advantages, and further provide for personalized call sheets that contain private notes intended for a targeted recipient, wherein the targeted recipient is the only recipient who knows of the note and can access the note.

While embodiments of the present invention are well suited for the generation and distribution of electronic call sheets to various recipients involved in a production shoot, other embodiments of the present invention are well suited to the generation and distribution of workforce organizing sheets that are used to manage the interactions of individuals on a project for a particular period of time. For instance, the workforce organizing sheet may be used to manage the interactions of individuals for a segment of a project that occurs over a period of a day. Also, in another implementation, the workforce organizing sheet may be used for crew and resource management for television crews operating at remote sites away from their home studio. Also, in still another implementation, the workforce organizing sheet may be used for event planning at a particular site.

### Notation and Nomenclature

Embodiments of the present invention can be implemented on software running on a computer system. Other embodiments of the present invention can be implemented on specialized or dedicated hardware running on a computer system, or a combination of software and hardware running on a computer system. The computer system can be a personal computer, notebook computer, server computer, mainframe, networked computer, handheld computer, personal digital assistant, workstation, and the like. This software program or its corresponding hardware implementation is operable for the generation and distribution of an electronic call sheet. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “determining,” “accessing,” “receiving,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the Application, the term “database” may be used to describe a location for storing information or data, and/or a mechanism for storing information or data. As such, “database” is interchangeable with the following terms: storage, data store, etc.

### Call Sheet Generation and Distribution

Embodiments of the present invention will enable the production industry, as well as other industries, to generate and distribute workforce organizing sheets, such as electronic call sheets in the production industry, by utilizing cutting edge mobile technology, as well as other network accessing technologies. This allows any user to generate an electronic or digital version of a “call sheet,” or any workforce organizing sheet, while digitally linking to various databases to provide an immediate digital, interactive document. Information contained within the call sheet can be loaded from various locations, including the user's network access device (e.g., mobile phone, mobile computing resource, stand-alone computing resource), a list of overall favorites, or particular job type favorites. Also, the call sheet may include linking and mapping features provided by third party vendors.

The production industry frequently utilizes a “call sheet” that is distributed daily to each person or entity involved in a production shoot. For example, a specific call sheet may be associated with a production shoot that is further limited to a single day's shoot or a segment of production shoot for a particular location. The call sheet may include scheduling information for the production shoot, or the segment of the production shoot. As such, a new call sheet is generated for every day a production shoot is on location, as the information can change from day to day.

The call sheet is used as a reference guide by persons involved in the production shoot and will include most if not all the information necessary to support a production shoot. The call sheet lets the cast and crew know what is going on during a production shoot, and what each person involved in the production shoot should be doing. A good call sheet will make the production shoot go smoothly. In summary, a call sheet is how producers plan each day or segment of a production shoot, including all the necessary information for the cast and crew, such as shoot location(s), applicable weather/lighting conditions, contact information for set personnel, local resources, police stations and services, hospitals, restaurants, and other vital information.

For instance, the call sheet will typically list all people involved in the production shoot so they have each other's contact information (e.g., director, assistant director, producer, cast, extras, crew, support staff, etc.). Also, the call sheet may include the name of the production company, as well as the client, for whom the multimedia content is made. In addition, the call sheet will present call times for those individuals that indicate when that individual should show up on location. A call time represents the time when relevant individuals are expected at a particular location (e.g., shoot location). The call sheet may include when the entire crew (a crew time) or a department, in general should show up to a particular location. The location or locations are also listed on the call sheet. Transportation and pick up times and locations may be provided for one or more individuals. As an example, if the location does not provide for easy access and parking, the production company may arrange for parking at a different site with transportation between the parking area and the shoot location. Breakfast or other meal times may also be included, with the ever important last call for the meal. The call sheet may include which scenes will be shot for a film production, the particular cast members involved in the shoot, and their corresponding pages in the script.

In addition, the call sheet may include other lists of resources or information that may be needed while on location For instance, a map or directions to a set or shoot location may be helpful if the location is not a commonly used studio. These instructions may also be provided for various vendors supporting the production shoot (e.g., restaurants, hospitals, police stations, etc.). Also, contact information may be included in the call sheet, such as phone numbers and address information to key vendors. Further, emergency constant information may be important, and includes directions to local services/hospitals, etc. Still other information can be included in a call sheet, such as safety notes, clothing recommendations, etc. Larger productions will include more information than smaller productions.

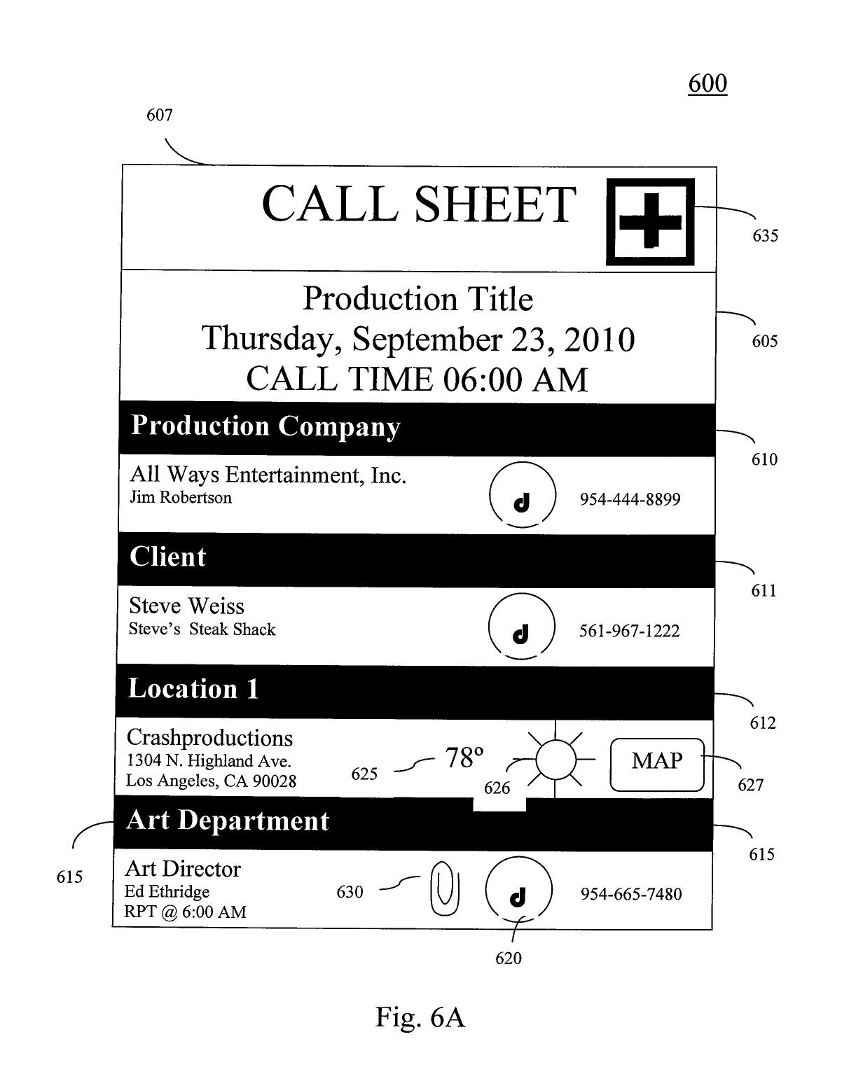

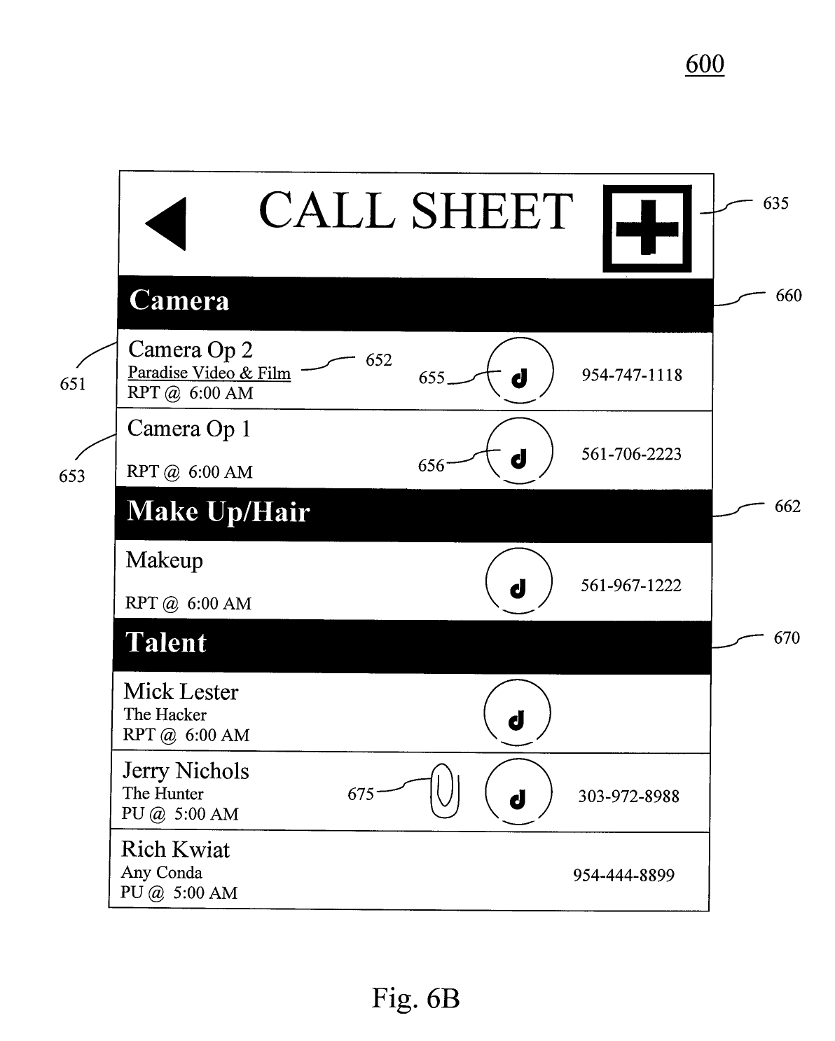

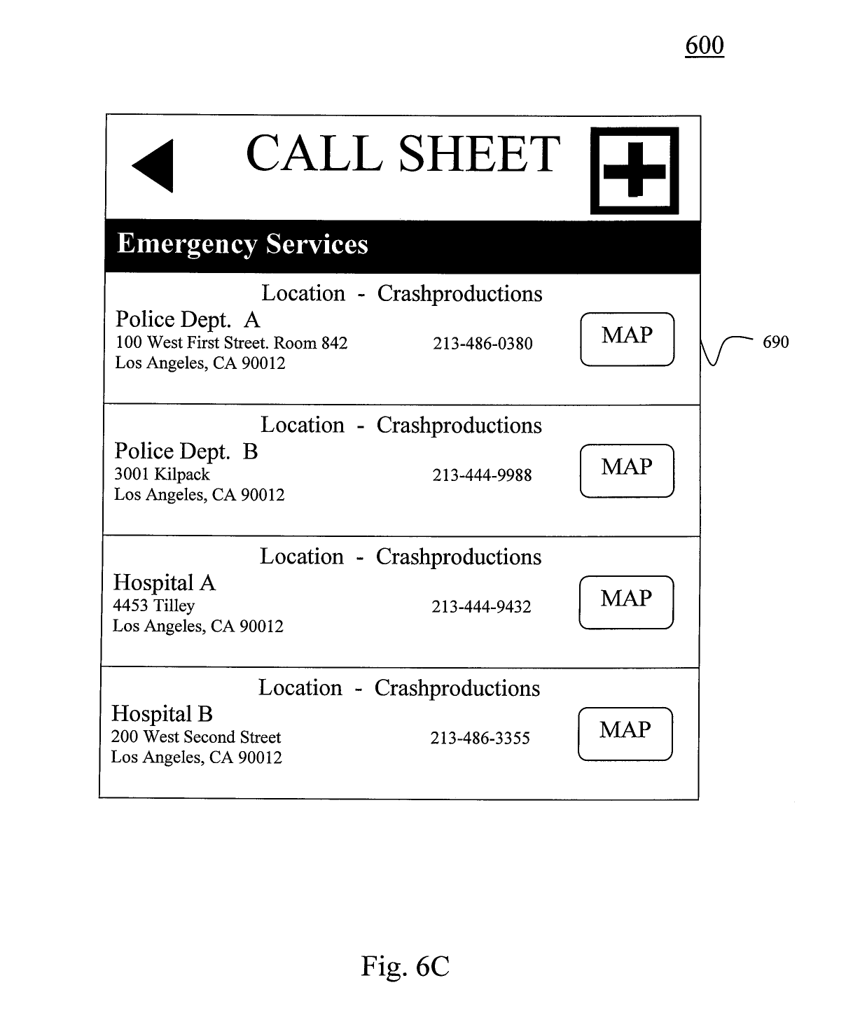

An exemplary call sheet 600 as generated and distributed by embodiments of the present invention is provided in FIGS. 6A-C. The call sheet includes the title of the production (e.g., “Production Title”), the date of the production shoot (e.g., Sep. 23, 2010), and the general call time (e.g., 6:00 AM) in FIG. 6A. In addition, the production company (All Ways Entertainment, Inc.) and the client (Steve Weiss) are provided. Other information, as listed by category within corresponding expansion bars are listed, such as the Location and Art Department in FIG. 6A; Camera, Make Up/Hair, and Talent in FIG. 6B; and Emergency Services in FIG. 6C.

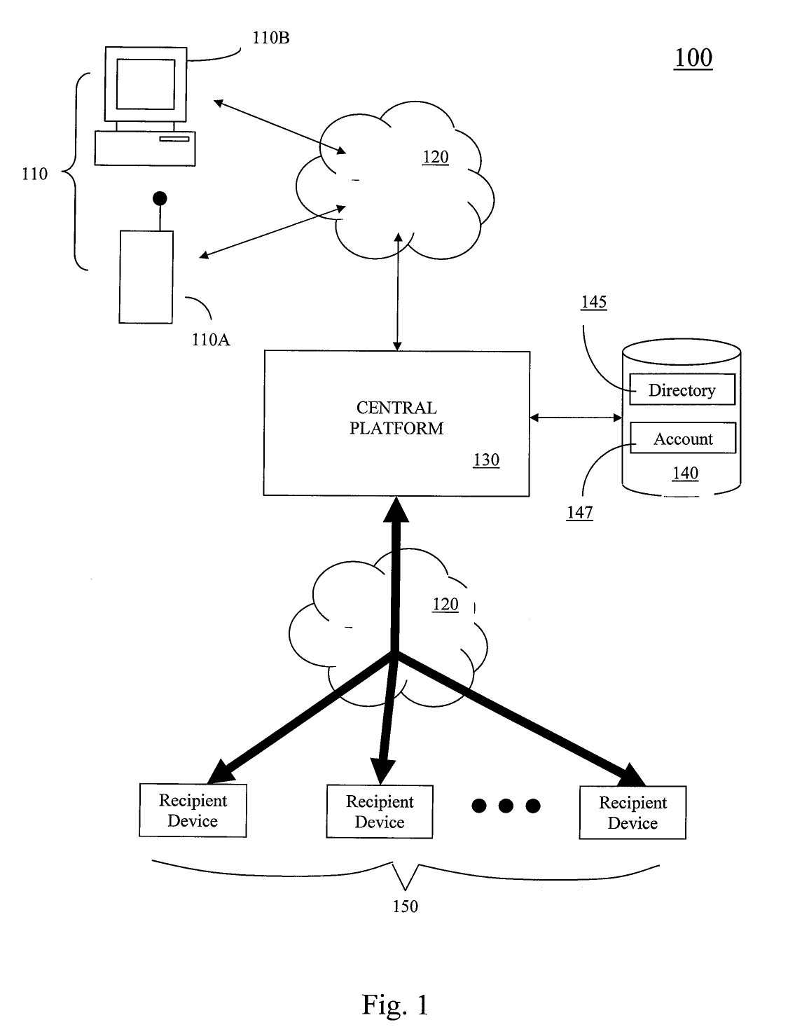

FIG. 1 is an illustration of a system 100 including a central platform 130 that is capable of supporting the generation and distribution of electronic or digital call sheets, in accordance with one embodiment of the present invention. The system 100 allows a user to access information needed to generate the electronic call sheet, and also facilitates the distribution of the electronic call sheet to various entities involved in a production shoot.

As shown in FIG. 1, a user is associated with various network access devices 110 for purposes of generating and distributing a call sheet. The user may be a production manager, director, or assistant director, for instance, that is responsible for the workflow on a production shoot.

In particular, the user is associated with a mobile device 110A (e.g., phone or computer resource) that is capable of accessing a communication network 120 to communicate with various back end servers supporting the generation and distribution of call sheets. In that manner, the user is able to generate and distribute the call sheet while on-the-go, and is not tied to a single location. Of course, the user is also associated with other computing resources 110B that are more static in nature, such as a stand-alone computer, that are also capable of accessing the communication network 120 to communicate with the various back end servers that facilitate the generation and distribution of call sheets.

As a result, the user is able to use a variety of computing resources in the generation and distribution of a single electronic call sheet. For instance, the user may start the process on the mobile device 110A, and finish the process on the stand-alone computer 110B, or any combination thereof.

The communication network 120 allows for communicative coupling of the user to various back end servers to facilitate the generation and distribution of the electronic call sheet. For instance, the communication network is the internet that allows the user to interface with various web servers supporting the generation and distribution of call sheets. In another instance, the communication network is any telecommunications network (e.g., a mobile phone network) that allows the user to interface with back-end servers.

System 100 also includes a central platform 130 that is used for the generation and distribution of electronic call sheets. Specifically, a user accesses the central platform 130 to access information included in the call sheet, and to manage the distribution of electronic call sheet to various recipients involved in a production shoot. In general, the central platform 130 gives the user the ability to plan, communicate with, and manage their workforce (e.g., those involved in a production shoot) from their mobile device (e.g., smart phone, mobile computing resource, etc.), or online through a network access device, to manage the generation and distribution of a call sheet.

The system also includes a data store 140 that includes a directory 145. The directory 145 includes listings for entities that provide products or services that support the production industry. For instance, actors may have a listing in the directory 145. Crew members may also provide their listing in the directory 145. Crew members include those individuals that are involved in producing the multi-media content, such as a camera operator, hair and makeup expert, costume designer, sound designer, construction coordinator, sound mixer, grip, gapher, etc. to name a few. In addition, other vendors that supply essential products and services supporting a production shoot are also listed in the directory 145. For instance, restaurants, hotels, beauty supplies, rental equipment suppliers, office suppliers, etc. may provide a listing within the directory 145.

In essence, the directory 145 is a specialized collection of information relevant to the production industry. Those in the production industry can access the directory 145 to obtain all the information regarding resources necessary to staff and run a production, and more specifically a production shoot. As such, a production company can access the listings in the directory 145 to find individuals necessary to man the cast and crew, as well as all support resources to manage the production shoot.

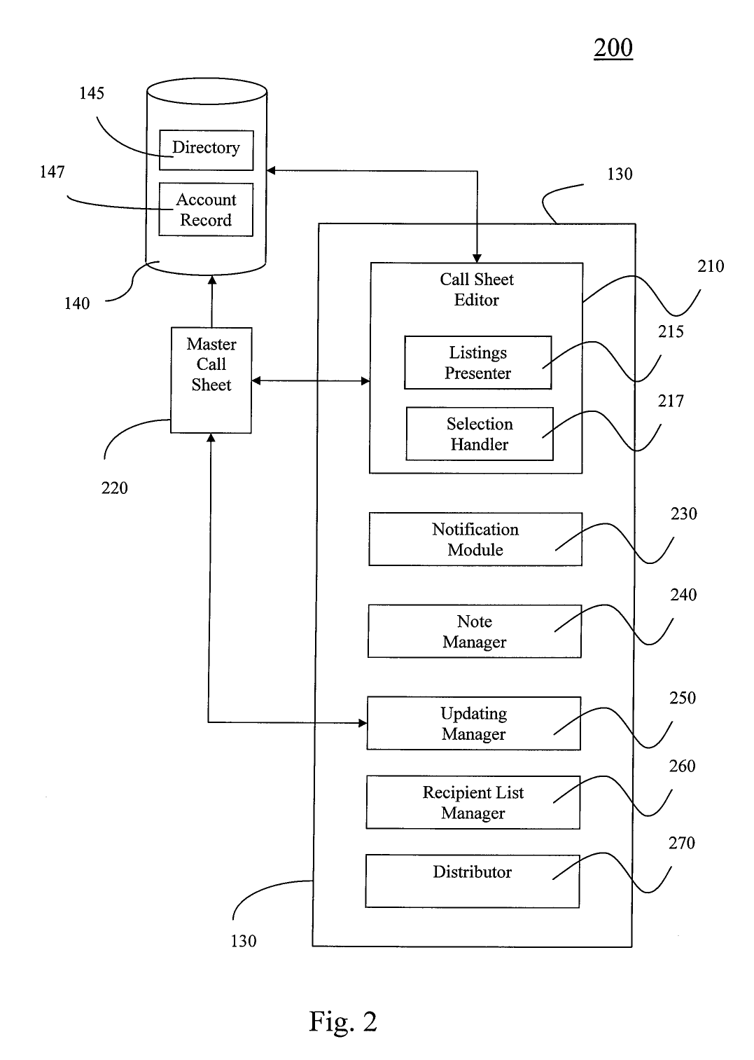

In addition, the data store 140 includes information related to the account record 147 of the user to facilitate the generation and distribution of the electronic call sheet. For instance, the account record 147 stores the most recent version of an electronic call sheet (e.g., master call sheet 220 of FIG. 2), draft call sheets, other completed call sheets, recent listings used by the user, favorite listings favored by the user to support a production shoot, etc.

Further, the central platform 130 facilitates the distribution of the electronic call sheet to various recipients. More specifically, central platform 130 is able to push or pull the electronic call sheet to various devices 150 associated with corresponding recipients involved in a production shoot via the communication network 120.

FIG. 2 is a block diagram of a back-end server 200 that includes the central platform 130, in accordance with one embodiment of the present invention. The back-end server 200 provides the functions and features that support the generation and distribution of an electronic call sheet by a user of the system 200.

While certain features of the central platform 130 are shown as located at the back end server 200, it is important to note that other embodiments of the present invention are well suited to placing those features on the computing resource associated with the user generating the electronic call sheet. That is, various features involved in the generation and distribution of the electronic call sheet may be performed, independently, or in parallel, or in support of the back end server, by the local computing resource associated with the user. In still other embodiments, various features involved in the generation and distribution of the electronic call sheet may be performed both by the local computing resource as well as the back-end server.

As shown in FIG. 2, system 200 includes the data store 140 that includes the directory 145 as well as the account record 147, as previously described. For instance, the directory 145 includes a plurality of listings of various entities providing products and/or services relevant to the production industry. That is, the directory 145 is a special directory, such as a production guide contacts data base, containing only listings related or relevant to the production industry, and more especially to supporting a production shoot. In addition, a master call sheet 220 is shown as being generated by the central platform 130 and stored in data store 140, and more specifically, being stored in association with account record 147.

System 200 includes central platform 130 that is accessed by the user to facilitate the generation and distribution of an electronic call sheet. The central platform 130 includes a call sheet editor 210 that interfaces with the user, for purposes of generating the call sheet. In particular, the call sheet editor 210 includes a listings presenter 215 that presents one or more listings for at least one category of information included in the call sheet, wherein the listings are taken from the directory 145 based on geographic information associated with the shoot location, a date of the production shoot being held at the shoot location, and an user selected location parameter provided by the user.

In one embodiment, the user selected location parameter is optionally included to further filter the listings presented to the user. More specifically, the user selected location parameter includes a range of distance, defining a geographic area including the location shoot, wherein the location shoot is generally located in the center of the geographic area.

More specifically, as the user is generating the call sheet, for a particular category of information, the listings presenter presents one or more listings that are suitable for selection by the user to fulfill products or services relevant to that category. For instance, the call sheet 600 shown in FIGS. 6A-C includes an “Art Department” category or subcategory 615. A user that is looking to find an individual providing services under the Art Department category is able to utilize the central platform and the listings presenter 215 to search for relevant listings as provided by the directory 145.

In one embodiment, the user is able to search for listings by name. That is, the user knows of a particular individual or entity that is able to supply products or services in support of the production shoot, and would like to include them within the electronic call sheet, and more particularly, in association with a particular category of the call sheet. As such, the user is able to access the central platform, and the listings presenter to find the listing associated with that entity or individual. In one use case, as the user begins typing in the name of the individual or entity, partial matches could be displayed for selection by the user. That individual or entity could be located anywhere in the world, as the user is specifically requesting their products and/or services.

In another embodiment, the user is able to search for listings by category. The category is any grouping of products and/or services that support the production industry. In addition, the category may be further defined as a subcategory, thus creating a category/subcategory pair from which listings are presented. For instance, a category may exist for a production designer, that also contains subcategories for the art department, the art directory, the set designer, the assistant art director, etc. The user is not looking for anyone specific, but is interested in one or more listings of entities or individual that can provide the products and/or services related to the category or subcategory of information within the call sheet.

In one embodiment, the listings are not filtered in that all listings are presented to the user. In other embodiments, the listings are filtered by some user selected location parameter. For instance the parameter may be a cap on the number of listings presented. In another case, the parameter may be defining a maximum distance from the location shoot, such that the individual or entity must be located within the maximum distance from the location shoot. In still other examples, the listings may be located within some upper limit (e.g., 200 miles) of the specified location (e.g., location shoot, user location, contact location, etc.). Of course, the parameter is adjustable, so that listings may be searched from anywhere between 5 to 200 miles, for example.

In another embodiment, the location parameter is associated with the location of the user. Specifically, a “Where I am now” feature takes into account the location of the user, or more specifically, the location of the device associated with the user, or any other location defined by the user. This location may be expressed as a geographic location, such as in degrees latitude and longitude.

In still another embodiment, the location parameter defines a zip code from within which to generate one or more listings to include within the call sheet. The zip code may be associated with the location shoot. In another embodiment, the location parameter defines a region, city, and/or state within which to generate and search for one or more listings to include within the call sheet. The city/state may be associated with the location shoot. In one case, if a city is selected, the geographic center of the city is used as a location seed, and contacts within that city are shown. In the case of the state parameter, only contacts in that state are shown to the user for further selection.

In another embodiment, a “Near Other Contact” feature provides for one or more listings that are presented in relation to another contact, or more specifically listings are provided within a geographic area of another contact, or in compliance with a parameter in association with that contact, or as defined by that contact. For instance, when contacts associated with the user are presented for selection. Upon selection of a selected contact, the contact's zip, or any other defined parameter by the user or contact, is used as the location parameter. In one case, only listings having the same zip code, and/or surrounding zip codes, as the contact are presented to the user for selection.

In another embodiment, one or more listings are also taken from the contact list of a device associated with the user. That is, the user may specify that contacts from their device are preferred for incorporation into the call sheet. In addition, the central platform is able to incorporate that contact information into the directory 145.

In one embodiment, the category of information is a required category. For instance, the category may define emergency contact information, such as for hospitals and/or police departments. This information is required for incorporation into the call sheet, in one implementation. As a result, for the required category, one or more listings are determined based on the previously defined geographic information, date and time associated with the location shoot. In addition, since the category is required, listings found may be automatically incorporated into the call sheet as defined by a second user selected location parameter defined specifically for emergency contact information. As an example, the parameter may define a cap on the number of listings, such as limiting hospital entries to the 2 nearest hospitals, and limiting police services to the 2 nearest police stations. The parameter may be a maximum distance, such that all listings within a certain range of the location shoot are included in the call sheet. Of course, in still other embodiments, the information is not automatically incorporated, as the collection of listings is presented to the user for selection and incorporation into the call sheet.

Once the listings are determined, the listings presenter 215 is able to present the one or more listings to the user for selection. The listings may be presented in any suitable order, such as alphabetically, from nearest to the location shoot to farthest to the location shoot or any other defined location, etc. In one embodiment, premium listings are presented more prominently, such as by listing them first regardless of an listing order selected by the user.

Also shown in FIG. 2 is a selection handler 217 within the call sheet editor 210. The selection handler receives a selection of the one or more listings presented. More specifically, when the user makes a selection, additional contact details are presented to the user so that the user can make an informed decision on whether to include that listing in the call sheet. Premium contacts within the directory 145 that are managed by the central platform 130 may include even more information. For instance, additional content may include reviews for that listing from other users of the central platform 130. Other information may include directions to the location of the listing, such as map information, or specific directions from a start position (e.g., shoot location, user's current location, etc.).

Once the selection is made by the user, the call sheet editor 130 adds this listing into the call sheet, or incorporates information related to the selection into the call sheet associated with the production shoot. More specifically, an entry in the call sheet is generated that includes information related to the listing. In addition, the listings may be further narrowed by the user to a favorites listing that the user favors when looking for resources to support a production shoot, or a recents listings, that contains recently accessed contact listings, as managed by the central platform 130 in the account record 147 associated with the user.

Listings from the favorites and/or recents features may be grouped by one or more categories. For instance, the user may only be interested in listings for a single category, or in another instance, the user has a full cast and crew ready for any production shoot, and is able to pull that information either from the favorites or recents. In addition, the favorites and/or recents features is associated with the user's account or use of the central platform 130, in one embodiment. In another embodiment, the favorites and/or recents features is associated with a device of the user. Also, the listing may be added to the contact list associated with the user for the account record 147, or for any device associated with the user.

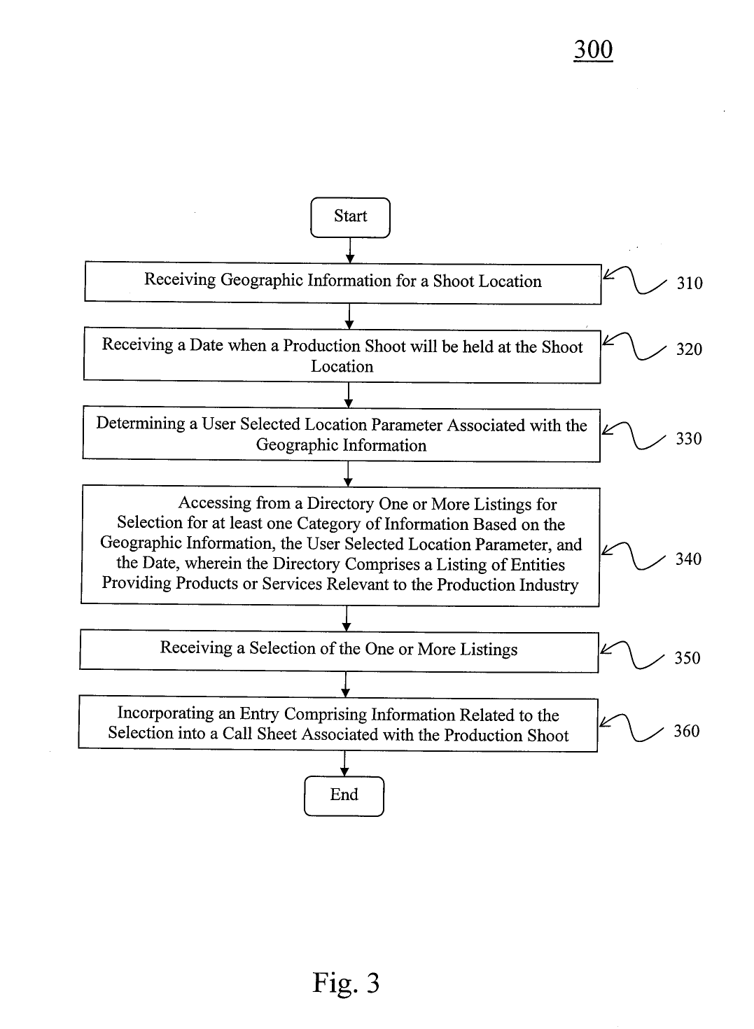

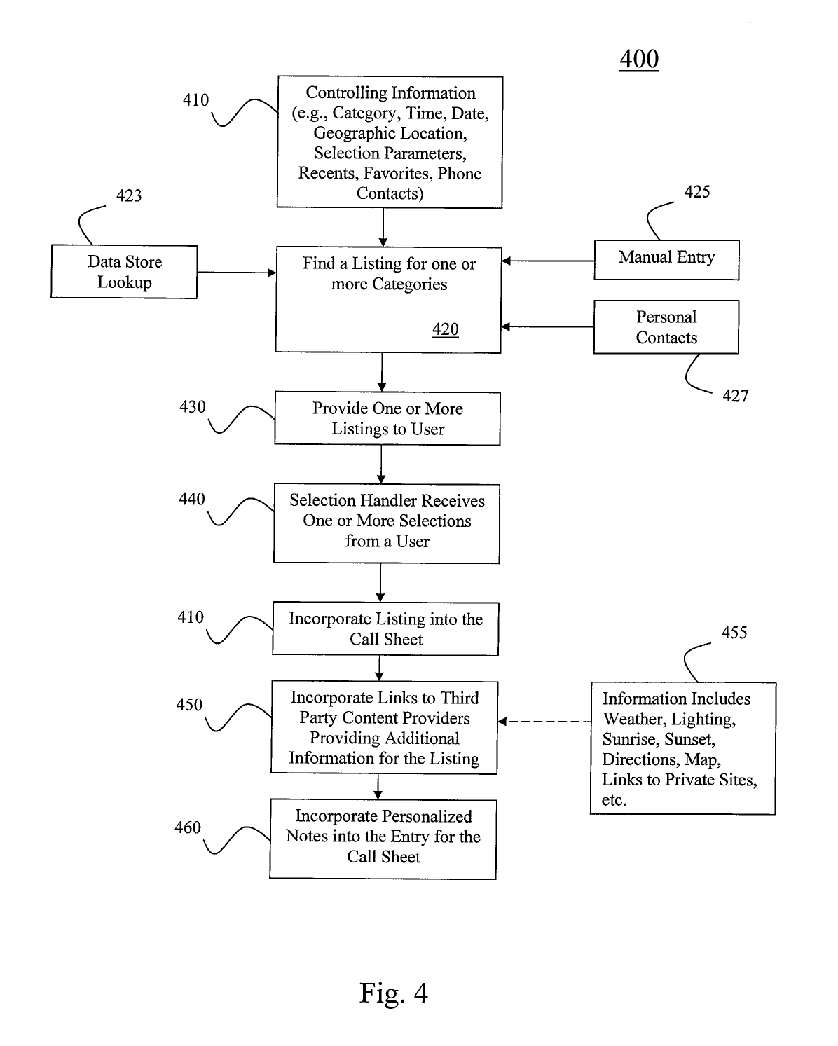

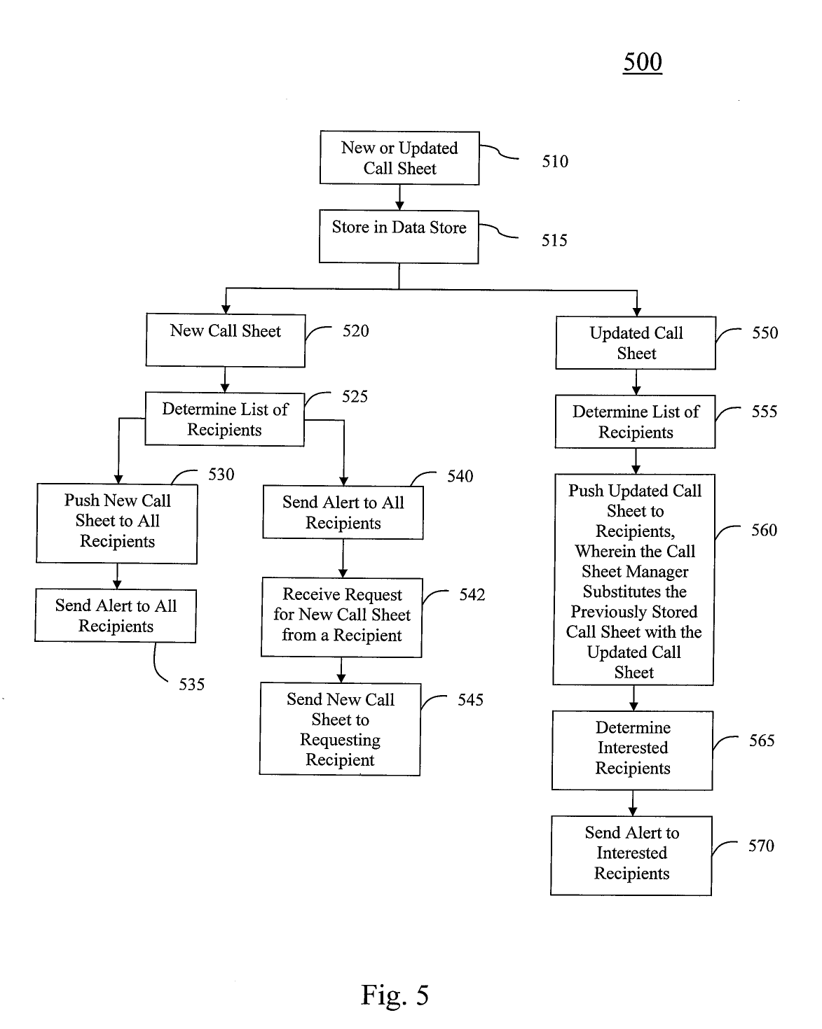

FIGS. 3-5 are diagrams that in combination illustrate the generation and distribution of call sheets, such as through the systems 100 and/or 200 of FIGS. 1 and 2. In particular, FIG. 3 is a diagram illustrating a flow chart 300 disclosing an overall method for generating and distributing information, such as an electronic call sheet, in accordance with one embodiment of the present invention. In one implementation, the method is implemented through a central platform for the generation and distribution of an electronic call sheet associated with a production shoot. FIG. 4 is a data flow diagram showing the flow of information when generating a call sheet, in accordance with one embodiment of the present invention. FIG. 5 is a data flow diagram showing the flow of information when distributing a new or updated call sheet, in accordance with one embodiment of the present invention.

Now turning to FIG. 3, geographic information is received for a shoot location 310. The geographic information is in any format suitable for defining a location, such as latitude and longitude coordinates, address, zip code, city/state, etc. The shoot location is where the production or generation of multimedia content occurs. For instance, in the case of a movie film, the shoot location is the area where a scene is captured.

In addition, a date is received 320 that is associated with a production shoot that will be held at the shoot location. Specifically, a production company is holding a production shoot on that date at that location. The call sheet provides scheduling and other information for that production shoot.

Further, a time for the production shoot is optionally received. That is, the start time or time period within which the production shoot is in operation is provided. Also, another important time in association with the production shoot is provided in one implementation. For instance, the time may define a representative period of time a cinematographer or photographer will be filming or shooting, wherein the cinematographer or photographer is interested in information related to that specific time (e.g., lighting conditions, weather conditions, etc.).

In relation to FIG. 4, controlling information, such as geographic information, date, and time, all of which are related to the shoot location is defined, delivered, and received 410 by the central platform 130 in systems 100 and 200. More particularly, when a user first interfaces with the central platform 130 that is used to generate and distribute a call sheet, information related to the shoot location, and time and date information of the production shoot is received by the call sheet editor 210 from the user.

In addition, a user selected location parameter is also received 320 and 410. The parameter is associated with the geographic information, and more specifically defines a search parameter used to search for listings in association with the location shoot. For instance, the search parameter may be a cap on the number of listings presented to the user. In another case, the search parameter may define a geographic area, in reference to the shoot location, within which to search for listings, particularly from the directory 145 managed by the central platform 130. In still another case, the location parameter may be a ratings filter, wherein ratings for listings are provided by users of the central platform 130 and the directory 145. As such, the location parameter may specify that only listings meeting a certain rating be provided for purposes of selection. Also, the location parameter may be a time period for operation. It is necessary that information is provided for resources that are able to provide product and/or services in support of the production shoot. For instance, if the production shoot is held on a holiday, after-hours, on a Sunday, then it would be important to provide listings for selection that have hours of operation coinciding with the date and time of the production shoot.

In relation to system 200 of FIG. 2, the user defines the location parameter used to filter the listings presented for selection and incorporation into the call sheet that is generated. The location parameter is used by the call sheet editor 210 to filter listings presented to the user.

Specifically, with reference to FIG. 3, one or more listings are accessed 340 from a directory. In one implementation, the directory 145 is managed by the central platform 130 for purposes of providing listings for selection. In addition, the listings that are presented are defined based on the geographic information associated with the location shoot, the user selected location parameter, and the date.

Also, with reference to FIG. 4, one or more listings 420 are found for one or more categories. In addition, the listings are accessed 423 through a data store lookup of the directory 145, or through manual entry by the user 425, or from personal contacts provided 427 by a device associated with the user.

More particularly, the one or more listings are provided for at least one category of information. A category of information describes a grouping of listings for individuals or entities that provide a particular product and/or service that supports a production shoot. In another case, the category of information defines listings from favorites listings defined by the user in association with the directory 145, or a recents listings as defined and used by the user in association with the directory 145.

In one embodiment, the listings may be presented for more than one category, especially if there are additional search parameters used that filter the number of listings presented to the user. For instance, if the search parameter is defined to pull information from the favorites or recents associated with the user, then the listings may include one or more categories, such as camera, actors, cast, crew, extras, set design, restaurants, etc. In another implementation, the search parameter is defined to pull information from the contacts of a device associated with the user, such as the mobile device 110A or web enabled device 110B interfacing with the central platform 130.

As previously described, the one or more listings are presented 430 to the user for selection. For instance, the listings are presented to the device associated with the user for display. As an example, the system 200 includes a listings presenter 215 that presents the one or more listings to a device associated with the user for generating and distributing the call sheet.

Once the user has made a selection, that selection is received 350, or more particularly, a selection handler in the central platform 130 receives 440 the one or more selections from the user. For instance, the selection may be received back at the central platform, or may be received and noted by an application on the device associated with the user to generate the call sheet. For example, selection handler 217 handles the selection.

Upon receipt, the selection is incorporated 410 into the call sheet. More specifically, an entry is generated that includes information related to the selection. That entry is therein incorporated into the call sheet associated with the production shoot. For example, the entry is incorporated into the call sheet by the call sheet editor 210 of system 200.

In addition, additional information may be included within each entry corresponding to a listing of information. For instance, a link may be incorporated 450 into an entry. The link accesses information provided by third party content providers. Information accessed may include 455 detailed weather, lighting, sunrise, sunset, directions, map, and other types of information. In addition, the link may be to a private site maintained by the entity associated with a particular entry. For instance, a link may provide immediate access to a production company that is capable of producing multimedia content. With reference to system 200, a linking engine facilitates the incorporation of a link that provides access to more detailed information for an entry including information related to a selection of listings, as incorporated into the call sheet.

Further, private notes may be incorporated 460 into a call sheet that is personalized to a particular recipient. That is, before delivering a call sheet to various recipients who are involved in the production shoot, a note or message from the user to a targeted recipient may be associated with the call sheet that is delivered to that recipient. More particularly, the call sheet is personalized to the targeted recipient through the association of a private note, and is delivered only to the targeted recipient. Remaining recipients of the call sheet are unaware of the private note to the targeted recipient.

Specifically, the user creating the call sheet generates a note that is intended for a recipient. For instance, referring back to FIG. 2, the user may interface with the note manager 240 to generate the note. The note is then stored in data store 140 for later access by the targeted recipient. That is, the recipient accesses the central platform 130 for access to the private note.

The personalized call sheet does not include the note, in one embodiment; however, in other embodiments a personalized call sheet can attach a private note directly. In the former case, an alert engine personalizes the call sheet by incorporating an alert that provides notification of the note. The call sheet is personalized since the alert is targeted solely to the intended recipient, and all other recipients do not receive the alert. As an example, notification module 230 generates an icon 430 for incorporation into the call sheet 400 of FIG. 4A, wherein the icon 430 provides notification to the targeted recipient of the call sheet 400 of a note. For instance, in FIG. 4A, the call sheet 400 may be intended for delivery to Ed Ethridge, the Art Director, along with a targeted alert via icon 430 (e.g., a paper clip) that provides notification of a note for Ed Ethridge from the user.

Activation of the alert, such as icon 430, will then begin a process of delivering the note to the targeted recipient, or more specifically allow the recipient to access the note. For instance, upon activation of the alert by the recipient, communication between the note manager 240 and the device associated with the recipient is established. Thereafter, the recipient is allowed access to the note stored in date store 140. For instance, the note is displayed in a window on the device associated with the recipient.

FIG. 5 is a data flow diagram 500 illustrating the flow of information when distributing a new or updated call sheet, in accordance with one embodiment of the present invention. The method outlined in FIG. 5 is used in conjunction with the methods outlined in FIGS. 3 and 4, in one implementation. That is, flow diagram 500 provides more detail as to the distribution of a call sheet that is generated.

More specifically, as shown in data flow diagram 500, a new or updated call sheet is generated 510. That is, the process outlined in flow diagram 500 is applicable for distributing new call sheets, or distributing modifications to call sheets (e.g., an updated call sheet). Generation of the new call sheet is outlined in flow diagrams 300 and 400 of FIGS. 3 and 4. The new call sheet is stored 515 in a data store.

Generating an updated call sheet may also follow the flow diagrams 300 and 400 in general, but more specifically, involve the receipt of new information that updates an existing call sheet. For instance, the user interfaces with the updating manager to define new and updated information. That new information is then incorporated into the call sheet by the updating manager 250 in order to generate an updated call sheet. The updated call sheet is stored 515 in a data store.

In particular, data flow diagram 500 discloses the distribution of a new call sheet 520. For instance, the distributor 270 in system 200 provides for the distribution of the call sheet, either through a push or pull process. In either process, a list of recipients is determined 525, each of which is distributed the corresponding call sheet at the appropriate time. For instance, the recipient list manager 260 interfaces with the user to determine the recipients. Also, contact information is also determined for each recipient, including a preferred method of delivery of the call sheet (e.g., email, fax, text message, etc.).

In one embodiment, the call sheet is pushed 530 to all the recipients. That is, the call sheet is delivered to a call sheet manager that is present on the network access device associated with a recipient. In the present case, the call sheet is delivered to corresponding call sheet managers associated with all the recipients. More particularly, for a corresponding recipient, the call sheet manager stores the call sheet in a known location on the device. In that manner, the call sheet manager is able to access the call sheet on the device for the benefit of the user. In addition, should there be any updates to the call sheet, the call sheet manager is able to locate the old call sheet for proper alignment with the updates.

In one particular embodiment, an alert is generated that provides notification of the new call sheet. That is, even though the call sheet has been pushed to preferred devices of intended recipients, those recipients may not be aware of the existence of the call sheet. As such, as previously described, an alert is generated by a notification module 230 that provides notification of the new call sheet, and is delivered 535 to all recipients. The alert may be in any communication format and is delivered to a network access device associated with a corresponding recipient. In one case, the alert is delivered 535 through a preferred method of communication for a corresponding recipient (e.g., text message, email, voice mail, etc.).

In another embodiment, the call sheet is pulled in response to a request for the call sheet from a requesting recipient. In particular, the call sheet is not immediately delivered to one or more recipients. Instead, an alert is generated by a notification module 230, wherein the alert provides notification of the call sheet, or more particularly provides notification of the existence of the call sheet. The alert is delivered 540 to the recipients, thereby informing the recipients of the existence of the new call sheet.

A recipient then requests the call sheet from the central platform. That is, the request is received by the central platform 130. Thereafter, the distributor 270 of system 200 delivers 545 the call sheet in response to the request to the network access device associated with the recipient. In that manner, the call sheet is pulled from the central platform 130 for delivery to the requesting recipient, or more specifically to a device associated with the recipient.

In another implementation, data flow diagram 500 discloses the distribution of updates to an existing call sheet, and more particularly, to the distribution of an updated call sheet 550. As previously described, the updated call sheet is generated by the receipt of new information updating an existing call sheet by an updating module or manager 250. The new information is incorporated into the call sheet to generate an updated call sheet.

For delivery, the distributor 270 in system 200 provides for the distribution of the updated call sheet. As before, a list of recipients is determined 555, each of which is distributed the corresponding updated call sheet at the appropriate time. The list of recipients for receiving the updated call sheet is typically the same as that for receiving the new call sheet, previously determined in 525. Again, contact information is determined for each recipient.

In the case of an updated call sheet, the updates may be last minute additions or modifications to certain portions of the call sheet. Since, the original or existing call sheet has been delivered to the list of recipients, or at least notification of original call sheet has been delivered, there may be more urgency in the delivery of the updated call sheet. That is, it would be preferred that any reference to a call sheet by a recipient the closer it is to the production shoot should include any updated information. As such, in one embodiment, the updated call sheet is pushed to all recipients. Of course, in another embodiment, the updated call sheet may be pulled by the recipients.

In particular, the call sheet is pushed 530 to all the recipients, in one embodiment. That is, the updated call sheet is delivered to corresponding call sheet managers that are present on corresponding network access devices associated with all the recipients. More particularly, for a corresponding recipient, the corresponding call sheet manager locates the existing or previously stored call sheet, and substitutes the old call sheet with the updated call sheet. For instance, the old call sheet is deleted, and the new call sheet is stored in the same or another known location on the corresponding device. In that manner, the call sheet manager is able to access the updated call sheet on the device for the benefit of the recipient.

In one particular embodiment, an alert is generated that provides notification of the updated call sheet to interested parties or recipients. That is, the updated information may only apply to certain interested parties. As an example, newly updated weather information may only be of interest to the cinematographer and camera operators, all of which can be grouped under a cinematography department. Newly updated weather information included in the updated call sheet is of particular interest to that department. On the other hand, since the updates only apply to weather, all the other information in the call sheet remains the same. In that case, recipients other than those in the cinematography department may not have an interest in the updated weather information, and need not view the updated call sheet that is deposited into their network access device.

As such, interested recipients are determined 565, such that those recipients are interested in the updated information. In addition, an alert is generated by a notification module 230 that provides notification of the updated call sheet. The alert is delivered 570 only to the interested recipients. That is, though the updated call sheet may be stored locally on a recipient's device, that recipient may not be aware of the updated call sheet, and the alert provides notification to that recipient of the existence of the updated call sheet. The alert may be in any communication format (e.g., text message, email, voice mail, fax, mail, etc.) and is delivered to a network access device associated with a corresponding interested recipient.

FIGS. 6A-C are illustrations of an exemplary call sheet 600 generated and distributed by the systems described in FIGS. 1 and 2, the method outlined in FIG. 3, and the data flow diagrams illustrated in FIGS. 4 and 5, in accordance with one embodiment of the present invention. Specifically, portions of one call sheet 600 are shown throughout FIGS. 6A-C.

In general, call sheet 600 is associated with a production shoot that is held at a shoot location. The call sheet is associated with geographic information related to the shoot location, as well as date and time information related to when the production shoot will be held. In addition, the call sheet 600 is also associated with a user selected location parameter that further limits the listings provided for selection and incorporation into the call sheet. Further, the call sheet includes at least one entry that includes information related to a selection of one or more listings provided for selection for a category of information. The listings are accessed from a directory of information relating to entities that provide products and/or services supporting the production industry. The one or more listings provided for selection are determined based on the previously referenced geographic information, user selected location parameter, and the date and time of the location shoot.

Looking at FIG. 6A, the call sheet 600 includes the title of the production (e.g., “Production Title”), the date of the production shoot (e.g., Sep. 23, 2010), and the general call time (e.g., 6:00 AM), all included in the title bar 607. Additionally, the production company that is producing the multimedia content during the production shoot is listed under the “Production Company” category and expansion bar 610 as All Ways Entertainment, Inc. with corresponding contact information (e.g., address and phone number). The call sheet 600 typically includes client contact information (e.g., Steve Weiss) under the “Client” expansion bar 611.

Other information provided in FIG. 6A includes other categories of information. For instance, as listed by category within corresponding category and expansion bars, these other categories include location information under the “Location” category and expansion bar 612. For instance, one or more shoot locations may be provided in a call sheet. Production shoots for both locations may occur simultaneously, overlap, or occur within their own time frame. In addition, a map icon 627 is optionally provided so that the user may access additional mapping and directions information from a third party content provider.

As shown in FIG. 6A, weather information is incorporated into the call sheet 600. That is, weather related information is accessed from third party content providers and incorporated into the call sheet 600. The latest most relevant information is incorporated into the call sheet. For instance, weather data is pulled from third party content providers for purposes of incorporation into the call sheet 600 based on the date, time, and geographic information related to the shoot location. In one embodiment, this information is automatically pulled and incorporated into the call sheet 600. As an example, temperature (e.g., 78 degrees) is pulled and incorporated in relation to the Crashproductions location under the Location category and expansion bar 612. In addition, a summary of the lighting and weather conditions (e.g., sunny conditions) is presented through the sun icon 626. In addition, icons 625 and 626 also perform an additional function by providing access (e.g., linking) to third party content providers for purposes of accessing additional information related to whether and lighting conditions.

In addition, the “Art Department” category and expansion bar 615 includes contact information for the specific art director used on the production shoot (e.g., Ed Ethridge). As shown in FIG. 6A, additional information for the art director may be accessed through the icon 620. Specifically, once activated, listing information for Ed Ethridge, in this example, is accessed in the directory 145, and provided to the user, as displayed in a corresponding network access device (e.g., mobile phone, stand-alone computer, etc.). In addition, a private notes icon 630 is provided that indicates a recipient of the call sheet 600 has a note from the user, as previously described.

Also, an emergency contact icon 635 is provided in the top bar 607. Activation of icon 635 brings the user to the emergency section of the call sheet 600, as referenced by the “Emergency Services” category and expansion bar 690 shown in FIG. 6C. For instance, information related to police services (e.g., Police Depts. A and B) are provided under this category. In addition, information related to hospitals (e.g., Hospitals A and B) are provided under this category. As shown in FIG. 6C, the listings in this Emergency Services category are provided based on geographic information, date, and time information relating to the shoot location, Crashproductions. In one embodiment, these listings are provided automatically. In another embodiment, these listings are provided to a user for selection based on geographic information, date, and time information relating to the shoot location.

Turning now to FIG. 6B, the “Camera” category and expansion bar includes contact information for the camera operators used on the production shoot. For instance, two camera operator companies are utilized in association with the production shoot, at the direction of the directory of photography: camera operator 2 with a listing 651 for Paradise Video and Film, and camera operator 1 with a listing 653. An additional link is provided in call sheet 600 to access a web site associated with Paradise Video and Film, as shown in FIG. 6B. Also, additional information provided in directory 145 is accessible through corresponding icons 655 and 656.

In addition, the “Make Up/Hair” category and expansion bar 662 includes contact information for the makeup crew used on the production shoot. Reporting call time of 6:00 AM is provided, as well as access to additional information provided in directory 145.

Further, the “Talent” category and expansion bar 670 includes contact information for cast members involved in the production shoot. For instance, listings for Mick Lester, Jerry Nichols and Rich Kwiat are provided. Additional information from directory 145 is accessible through corresponding icons for Mick Lester and Jerry Nichols. Rich Kwiat does not have a corresponding directory listing, and may have been incorporated through manual entry or through a user's personal contact information. In addition, private notes are available for Jerry Nichols, as accessible through the note icon 675. In this case, the call sheet may be personalized to Jerry Nichols, as previously described (i.e., only alerts for notes to Jerry Nichols will be shown in call sheet 600 that is only delivered to Jerry Nichols).

Embodiments of the present invention are well suited to providing organization to work crews in the field for a variety of industries, in addition to the production industry. For instance, the systems and methods described above in FIGS. 1-5 are well suited to the generation and distribution of workforce organizing sheets that are used to manage the interactions of individuals on a project or event for a particular period of time. In particular, geographic information is received for a location where the project or event is being held. In addition, a date is received when the project or event is being performed or held at the location. A user selected location parameter that is associated with the geographic information is determined, and is used to filter information presented to the user for selection. One or more listings are accessed for selection by the user. The listings are collected in association with at least one category of information based on the geographic information, the user selected location parameter, and the date. The directory includes a listing of entities providing products or services that are capable of supporting the project or event. Thereafter, an entry including information related to the selected listing is incorporated into a workforce organizing sheet associated with the project or event.

The method outlined above for generating and distributing a workforce organizing sheet is applicable in various industries. In one example, the workforce organizing sheet may be used to manage the scheduling of a project or event, to include managing the various resources, entities, and locations supporting a specific project, job, event. For instance, the workforce organizing sheet may be used to manage interactions of individuals for a project that occurs over a period. Also, in another implementation, the workforce organizing sheet may be used for crew and resource management for television crews operating at remote sites. Also, in still another implementation, the workforce organizing sheet may be used for planning and running an event at a particular site for a particular time period.

A system and method for the generation and distribution of electronic call sheets is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The one or more present inventions, in various embodiments, include components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes (e.g., for improving performance, achieving ease and/or reducing cost of implementation).

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed:

1. A method for distributing information, comprising:
receiving geographic information for a shoot location;
receiving a date when a production shoot will be held at said shoot location;
determining a user selected location parameter associated with said geographic information;
accessing from a directory one or more listings for selection for at least one category of information based on said geographic information, said user selected location parameter, and said date, wherein the directory comprises a listing of entities providing products or services relevant to the production industry;
receiving a selection of said one or more listings; and
incorporating an entry comprising information related to the selection into a call sheet associated with the production shoot.

2. The method of claim 1, further comprising:
determining one or more recipients;
determining contact information for each recipient; and
sending said call sheet to a call sheet manager of a network accessible device associated with a recipient in said list, wherein said call sheet manager stores said call sheet in a known location on said device.

3. The method of claim 2, further comprising:
sending an alert to view said call sheet to said network accessible device.

4. The method of claim 2, further comprising:
receiving new information updating said call sheet;
incorporating said new information into said call sheet and generating an updated call sheet;
sending the updated call sheet to said call sheet manager for storing on said device, wherein said call sheet manager substitutes said call sheet with said updated call sheet.

5. The method of claim 4, further comprising:
storing said updated call sheet in said data store.

6. The method of claim 4, further comprising:
determining that said recipient is an interested party having interest in said new information; and
sending an alert to said device providing notification of said updated call sheet.

7. The method of claim 1, wherein said accessing from a directory further comprises:
determining said one or more listings from a group consisting essentially of a list of favorites in said directory for a user, and a list of recents from said directory for said user.

8. The method of claim 1, further comprising:
adding a listing to said one or more listings from an address book of a network access device used by said user for generating said call sheet.

9. The method of claim 1, further comprising:
accessing said one or more listings for said category of information that is required;
determining one or more relevant listings based on a second user selected location parameter (caps, etc.);
incorporating information related to said one or relevant listings into said call sheet.

10. The method of claim 9, wherein said required category is taken from a group consisting essentially of entities providing police services and medical services.

11. The method of claim 1, further comprising:
storing said call sheet in a data store.

12. The method of claim 1, further comprising:
generating a message intended for a recipient;
storing said message in a data store;
incorporating an alert providing notification of said message into said call sheet that is personalized to said recipient by targeting said alert only to said recipient; and
sending said message to said recipient upon activation of said alert.

13. The method of claim 1, further comprising:
accessing weather related information based on said date and said geographic information; and
incorporating said weather related information into said call sheet.

14. The method of claim 13, further comprising:
sending said call sheet to a call sheet manager of a network accessible device associated with a recipient, wherein said call sheet manager stores said call sheet in a known location on said device
receiving updated weather related information;
incorporating said updated information into said call sheet to generate an updated call sheet; and
sending said updated call sheet to said call sheet manager for storing on said device, wherein said call sheet manager substitutes said call sheet with said updated call sheet.

15. A platform for distributing information, comprising:
a directory comprising a plurality of listings of entities providing products or services related to the production industry;
a listings presenter for presenting one or more listings for at least one category of information from said directory based on geographic information associated with a shoot location, a date of a production shoot held at said shoot location, and a user selected location parameter provided by a user;
a selection handler for receiving a selection of said one or more listings; and
a call sheet editor for incorporating information related to said selection into a call sheet associated with said production shoot.

16. The platform of claim 15, further comprising:
a distributor for sending the call sheet to a call sheet manager of a network accessible device associated with a recipient.

17. The platform of claim 16, wherein said distributor sends said call sheet in response to a request for said call sheet in association with said recipient.

18. The platform of claim 15, further comprising:
a notification module for generating an alert providing notification of said call sheet and sending said alert to at least one network accessible device associated with one or more recipients.

19. The platform of claim 16, wherein said call sheet editor further comprises:
an updating module for receiving new information updating said call sheet, and incorporating said new information into said call sheet and generating an updated call sheet; and
wherein said distributor sends said updated call sheet to said call sheet manager.

20. The platform of claim 19, further comprising:
a notification module for determining that said recipient is an interested party having interest in said new information, and for generating an alert providing notification of said updated call sheet and sending said alert to said network accessible device for display.

21. The platform of claim 15, further comprising:
a data store for storing said call sheet.

22. The platform of claim 15, further comprising:
a linking engine for including a link in the information related to the selection incorporated into the call sheet, wherein said link accesses additional information related to said selection in said directory.

23. The platform of claim 15, wherein said user selected location parameter is taken from a group consisting essentially of a radius, a zip code, a city, a region, a state, a rating.

24. The platform of claim 15, further comprising:
a notes manager for generating a message intended for a recipient of said call sheet;
a data store for storing said message;
an alert engine for incorporating an alert providing notification of said message into said call sheet that is personalized to said recipient by targeting said alert only to said recipient; and
wherein said notes manager sends said message to said recipient upon activation of said alert.

25. An electronic call sheet comprising:
geographic information for a shoot location;
a user selected location parameter;
a date when a production shoot will be held at said shoot location;
at least one entry incorporated into a call sheet associated with said production shoot, wherein said entry comprises information related to a selection of one or more listings provided for selection for a category of information that is accessed from a directory, wherein said one or listings is determined based on said geographic information, said user selected location parameter, and said date.

26. The electronic call sheet of claim 25, further comprising:
a link to a third party content provider to access additional information related to said entry.

27. A method for organizing, comprising:
receiving geographic information for a location;
receiving a date when a project will be performed at said shoot location;
determining a user selected location parameter associated with said geographic information;
accessing from a directory one or more listings for selection for at least one category of information based on said geographic information, said user selected location parameter, and said date, wherein the directory comprises a listing of entities providing products or services in support of the project;
receiving a selection of said one or more listings; and
incorporating an entry comprising information related to said selection into a workforce organizing sheet associated with the project.
